(19) United States
(12) Patent Application Publication
(10) Pub. No.: US 2005/0172858 A1
(43) Pub. Date: Aug. 11, 2005

(54) Preparations containing at least one diformate

(75) Inventors: Michael Schonherr, Frankenthal (DE); Jorn Karl, Mannheim (DE); Alexander Hauk, Ludwigshafen (DE); Gerd Diebold, Reutlingen (DE); Andreas Habich, Speyer (DE); Robert Lenz, Hochdorf-Assenheim (DE); Anna Valeska Lohmann, Limburgerhof (DE); Volker Schmidt, Mannheim (DE); Leif Hjornevik, Skien (DE)

Correspondence Address: LAHIVE & COCKFIELD, LLP., 28 STATE STREET, BOSTON, MA, 02109, US

(73) Assignee: Basf Aktiengesellschaft

(21) Appl. No.: 10/521,202

(22) PCT Filed: Jul. 7, 2003
(86) PCT No.: PCT/EP03/07250

(30) Foreign Application Priority Data
Jul. 12, 2002 (DE) 10231891.3
Jul. 12, 2002 (DE) 10231895.6
Nov. 15, 2002 (DE) 10253594.9

(51) Int. Cl. C09K 3/00

(52) U.S. Cl. 106/287.24; 523/200

(57) ABSTRACT

The present invention relates to coated preparations comprising at least one diformate of the general formula XH(COOH)₂, where X is Na, K, Cs, NH₄ and to the use thereof.

The present invention relates to coated preparations comprising at least one diformate, and to the use of these preparations.

Acid formates and methods for preparing them have been known for a very long time. Thus, Gmelins Handbuch der anorganischen Chemie, 8th edition, number 21, pages 816 to 819, Verlag Chemie GmbH, Berlin 1928, and number 22, pages 919 to 921, Verlag Chemie GmbH, Berlin 1937, describe the preparation of sodium diformate and of potassium diformate by dissolving sodium formate and potassium formate in formic acid. The crystalline diformates can be obtained by lowering the temperature or by evaporating off excess formic acid.

DE 424017 discloses the preparation of acid sodium formates of varying acid content by introducing sodium formate into aqueous formic acid in the appropriate molar ratio. The corresponding crystals can be obtained by cooling the solution.

According to J. Kendall et al., Journal of the American Chemical Society, Vol. 43, 1921, pages 1470 to 1481, acid potassium formates can be obtained by dissolving potassium carbonate in 90% strength formic acid, with formation of carbon dioxide. The corresponding solids can be obtained by crystallization.

GB 1,505,388 discloses the preparation of acid carboxylate solutions by mixing the carboxylic acid with a basic compound of the required cation in aqueous solution. Thus, for example, aqueous ammonia is employed as basic compound in the preparation of acid ammonium carboxylate solutions.

U.S. Pat. No. 4,261,755 describes the formation of acid formates by a reaction of an excess of formic acid with the hydroxide, carbonate or bicarbonate of the appropriate cation.

WO 96/35657 discloses the preparation of products which comprise disalts of formic acid by mixing potassium, sodium, cesium or ammonium formate, potassium, sodium or cesium hydroxide, carbonate or bicarbonate or ammonia with optionally aqueous formic acid, subsequent cooling of the reaction mixture, filtration of the resulting suspension and drying of the resulting filter cake, and recycling of the filtrate.

The unpublished German applications DE 101 547 15.3 and DE 102 107 30.0 describe processes for the preparation of formates.

Acid formates have an antimicrobial effect and are employed for example for preserving and acidifying vegetable and animal materials such as, for example, grasses, agricultural products or meat, for treating biowastes or as additive for livestock nutrition.

WO 96/35337 A1 describes animal feeds and animal feed additives which contain diformates, especially potassium diformate.

WO 97/05783 A1 (EP 845 947 A1) describes a method of cooling and preservation of fish in which a cooling medium with formic acid and/or mono/di or tetrasalts of formic acid is employed. In one embodiment, a C1 to C4 monocarboxylic acid is added to the cooling medium.

WO 98/19560 (EP 957 690 A1) describes a method for producing a fish feed in which ammonium, sodium or potassium diformate and formic acid are added to a fish product before addition of further ingredients of the feed and processing to fish feed.

WO 98/20911 A1 (EP 961 620 B1) describes a method for treating wet organic waste in which an aqueous preparation of the mono- and disalts of formate, acetate or propionate is employed.

WO 01/19207 A1 describes a liquid preservative/acidifier for grass and agricultural products, fish and fish products, and meat products, which contains at least 50% by weight formic acid and formates, ammonium tetraformate and 2-6% by weight potassium or 2-10% by weight sodium in the form of their hydroxides or formates.

The diformates obtainable according to EP 0 824 511 B1 can be dried in a step following the production process. The resulting products are in the form of powders and usually contain less than 5% by weight water. The diformates obtainable in this way are, however, unsuitable for formulation in complex substrates.

Commercially available diformate-containing preparations as can be obtained, for example, under the name FORMI™ for livestock nutrition usually cannot be incorporated into so-called premixes because agglomeration and/or caking of the premix occurs and makes further processing of the premix to feeds impossible.

Feeds are produced by preparing so-called “premixes” or “base mixes” from vitamins, minerals, trace elements, organic acids and, where appropriate, enzymes and then mixing them with the other ingredients of the feed. Admixture of the diformates known in the prior art (e.g. those obtainable as described in EP 0 824 511 B1) in a “premix” results in agglomeration and caking, and degradation of the ingredients of the premix.

It is an object of the present invention to provide preparations which make it possible to incorporate diformates into complex substrates, for example into animal feeds or premixes for animal feeds, without agglomeration or caking of the substrate occurring. It is of particular interest in this connection for the other ingredients of the complex substrate not to be influenced by the admixture. Particularly important complex substrates are the so-called “base mixes” as are conventionally used for producing feeds.

We have found that this object is achieved by the preparations of the invention.

The present invention accordingly relates to coated preparations comprising at least one diformate of the general formula
XH(COOH)₂, where X is Na, K, Cs, NH₄.

The term “coated preparations” includes in this connection all preparations in which at least 50, in particular at least 70, very particularly preferably at least 80, especially at least 90, % of the surface of the particles of the preparation is covered. The terms “coated”, “encapsulated” and “enveloped” are used synonymously for the purposes of the present application. Correspondingly, the terms coating material enveloping material and coating material are used synonymously.

Coated preparations are, in particular, preparations which remain substantially chemically unchanged in contact with calcium carbonate, compared with uncoated preparations. A parameter for the chemical change in the diformates is the liberation of CO₂.

The invention includes preparations comprising at least one diformate of the general formula
XH(COOH)₂, where X is Na, K, Cs, NH₄, and
at least one coating material.
Diformates

Diformates and their preparation are described in the prior art. The diformates to be employed according to the invention are obtainable for example by the process described in EP 0 824 511 B1 or by the processes described in the as yet unpublished German patent applications DE 101 547 15.3 and DE 102 107 30.0.

Suitable diformates are sodium diformate, potassium diformate, cesium diformate and ammonium diformate. In a preferred embodiment, potassium diformate is employed as diformate. In a further embodiment, said diformates can be employed mixed with one another.

The term “diformates” is used hereinafter and includes both preparations comprising at least one diformate, and preparations comprising mixtures of said diformates.

Coating Materials

Coating materials which can be employed are all materials able to cover at least 50%, in particular at least 70, very particularly preferably at least 80, especially at least 90, % of the surface of preparations comprising at least one diformate.

Coating materials which can be employed are all materials able to coat preparations comprising at least one diformate in such a way that the latter remain chemically unchanged in contact with calcium carbonate.

A parameter for a chemical change in the diformates is the liberation of CO₂. This is determined by the following method:

20 g each of limestone and sample are mixed in a 100 ml Erlenmeyer flask which is connected via an adaptor with tubing to a measuring cylinder which is filled with water and suspended inverted. The Erlenmeyer flask is shaken at 500 rpm/min on a shaker plate, and the resulting CO₂ is collected in the measuring cylinder. The measurement is carried out at room temperature (20° C.). The CO₂ liberation is measured over a period of 200, 600 and 800 minutes. Suitable coating materials are all compounds which afford coated preparations comprising at least one diformate for which the liberation of CO₂ is less than 100 ml, in particular less than 50 ml of CO₂, in particular less than 25 ml of CO₂, after 200 minutes.

The skilled worker will choose the coating method depending on the coating material employed.

In a preferred embodiment, the coated preparations of the invention are provided with a coating material which comprises at least one compound selected from the group consisting of
a) polyalkylene glycols, especially polyethylene glycols with a number average molecular weight of about 400 to 15 000, such as, for example, 400 to 10 000;
b) polyalkylene oxide polymers or copolymers with a number molecular weight of about 4000 to 20 000, in particular block copolymers of polyoxyethylene and polyoxypropylene.
c) Substituted polystyrenes, maleic acid derivatives and styrene/maleic acid copolymers
d) polyvinylpyrrolidones with a number average molecular weight of about 7000 to 1 000 000;
e) vinylpyrrolidone/vinyl acetate copolymers with a number average molecular weight of about 30 000 to 100 000
f) polyvinyl alcohol with a number average molecular weight of about 10 000 to 200 000, polyphthalic acid vinyl esters
g) hydroxypropylmethylcellulose with a number average molecular weight of about 6000 to 80 000.
h) Alkyl (meth)acrylate polymers and copolymers with a number average molecular weight of about 100 000 to 1 000 000, especially ethyl acrylate/methyl methacrylate copolymers and methacrylate/ethyl acrylate copolymers,
i) polyvinyl acetate with a number average molecular weight of about 250 000 to 700 000, where appropriate stabilized with polyvinylpyrrolidone
j) polyalkylenes, especially polyethylenes
k) phenoxyacetic acid/formaldehyde resin
l) cellulose derivatives such as ethylcellulose, ethylmethylcellulose, methylcellulose, hydroxypropylcellulose, hydroxypropylmethylcellulose, carboxymethylcellulose, celluloseacetate phthalate
m) animal, vegetable or synthetic fats
n) animal, vegetable or synthetic waxes or chemically modified animal, vegetable waxes such as beeswax, candelilla wax, carnauba wax, montan ester wax and rice germ oil wax, spermaceti, lanolin, jojoba wax, Sasol wax, Japan wax or Japan wax substitute.
o) Animal and vegetable proteins such as, for example, gelatin, gelatin derivatives, gelatin substitutes, casein, whey, keratin, soybean protein; zein and wheat protein
p) mono- and disaccharides, oligosaccharides, polysaccharides, e.g. starches, modified starches and pectins, alginates, chitosan, carrageenans
q) vegetable oils, e.g. sunflower, safflower, cottonseed, soybean, corn germ, olive, rape (seed), linseed, olive, coconut, (oil) palm kernel oil and palm oil.
r) synthetic or semisynthetic oils, e.g. medium chain-length triglycerides or mineral oils
s) animal oils such as, for example, herring, sardine and whale oil
t) hardened (hydrogenated or partially hydrogenated) oils/fats such as, for example, from the abovementioned in particular hydrogenated palm oil, hydrogenated cottonseed oil, hydrogenated soybean oil
u) lacquer coatings such as, for example, terpenes, especially shellac, tolu balsam, Peru balsam, sandarac and silicone resins
v) fatty acids, both saturated and mono- and polyunsaturated C6 to C24 carboxylic acids
w) silicas
x) benzoic acid and/or salts of benzoic acid and/or esters of benzoic acid and/or derivatives of benzoic acid and/or salts of benzoic acid derivatives and/or esters of benzoic acid derivatives.

Said coating materials can also be employed mixed with one another.

Examples which should be mentioned of suitable polyalkylene glycols a) are: polypropylene glycols and, in particular, polyethylene glycols of varying molecular mass such as, for example, PEG 4000 or PEG 6000, obtainable from BASF AG under the proprietary names Lutrol E 4000 and Lutrol E 6000.

Examples which should be mentioned of above polymers b) are: polyethylene oxides and polypropylene oxides, ethylene oxide/propylene oxide copolymers, and block copolymers composed of polyethylene oxide and polypropylene oxide blocks, such as, for example, polymers which are obtainable from BASF AG under the proprietary name Lutrol F68 and Lutrol F127.

It is possible and advantageous to employ highly concentrated solutions of the polymers a) and b), of up to about 50% by weight, such as, for example, about 30 to 50% by weight, based on the total weight of the solution.

Examples which should be mentioned of above polymers d) are: polyvinylpyrrolidones like those marketed for example by BASF AG under the proprietary name Kollidon or Luviskol. It is possible and advantageous to employ highly concentrated solutions of these polymers having a solids content of about 30 to 40% by weight, based on the total weight of the solution.

An example which should be mentioned of abovementioned polymers e) is: a vinylpyrrolidone/vinyl acetate copolymer which is marketed by BASF AG under the proprietary name Kollidon VA64 or Kollicoat SR. It is possible and particularly advantageous to use highly concentrated solutions of these copolymers, of about 30 to 40% by weight, based on the total weight of the solution.

Examples which should be mentioned of above polymers f) are: products like those marketed for example by Hoechst under the proprietary name Mowiol. It is possible and advantageous to employ solutions of these polymers having a solids content in the range from about 8 to 20% by weight.

Examples which should be mentioned of suitable polymers g) are: hydroxypropylmethylcelluloses like those marketed for example by Shin Etsu under the proprietary name Pharmacoat.

Examples which should be mentioned of abovementioned polymers h) are: alkyl (meth)acrylate polymers and copolymers whose alkyl group has 1 to 4 carbon atoms. Specific examples which should be mentioned of suitable copolymers are: ethyl acrylate/methyl methacrylate copolymers which are marketed for example under the proprietary name Kollicoat EMM 30D by BASF AG or under the proprietary name Eudragit NE 30 D by Röhm; and methacrylate/ethyl acrylate copolymers like those marketed for example under the proprietary name Kollicoat MAE 30DP by BASF AG or under the proprietary name Eudragit 30/55 by Röhm. Copolymers of these types can for example be processed according to the invention as 10 to 40% by weight dispersions.

Examples which should be mentioned of above polymers i) are: polyvinyl acetate dispersions which are stabilized with polyvinylpyrrolidone and are marketed for example under the proprietary name Kollicoat SR 30D by BASF AG (solids content of the dispersion about 20 to 30% by weight).

Fats, e.g. those of animal, vegetable or synthetic origin; examples of animal fats m) which may be mentioned are fats from pigs, cattle and geese, with beef tallow for example being suitable. A suitable beef tallow is obtainable under the proprietary name Edenor NHIT-G (CAS No. 67701-27-3) from Cognis.

Further coating materials are gelatin, for example from cattle, from pigs, from fish.

Further coating materials are waxes, e.g. vegetable waxes such as, for example, candelilla wax, carnauba wax, rice germ oil wax, Japan wax or Japan wax substitute (obtainable under the proprietary name Japanwachsersatz 2909, Kahl Wachsraffinerie) etc.; synthetic waxes such as cetyl palmitate (obtainable under the proprietary name Cutina CP, CAS 95912-87-1 from Cognis), animal waxes such as, for example, lanolin, beeswax, shellac wax, spermaceti, and chemically modified waxes such as jojoba wax, Sasol wax, montan ester wax.

Also conceivable in principle are other coatings from solution, e.g. sugar coating.

Consideration may likewise be given to vegetable oils q), e.g. sunflower, safflower, cottonseed, soybean, corn germ and olive oils, rapeseed, linseed, olive, coconut, (oil) palm kernel and (oil) palm oils. Suitable palm oils are obtainable for example under the proprietary name Vegelol PR 265 from Aarhus Oliefabrik. Suitable rape(seed) oils are obtainable under the proprietary name Vegeol PR 267 from Aarhus Oliefabrik. Palm kernel oil is obtainable under the proprietary name Tefacid Palmic 90 (CAS No. 57-10-3) from Karlshamns.

Consideration may likewise be given to semisynthetic oils r), e.g. medium chain-length triglycerides or mineral oils and/or animal oils s), e.g. herring, sardine and whale oils.

In a preferred embodiment, the coating materials employed are hydrogenated vegetable oils t) including triglycerides such as, for example, hydrogenated cottonseed, corn, peanut, soybean, palm, palm kernel, babassu, sunflower and safflower oils. Preferred hydrogenated vegetable oils include hydrogenated palm oil, cottonseed oil and soybean oil. The most preferred hydrogenated vegetable oil is hydrogenated soybean oil. Other fats and waxes derived from plants and animals are likewise suitable.

The hydrogenated vegetable oils which are preferably employed can exist in various polymorphous forms which are the α, β and β′ form. In a particularly preferred embodiment of the present invention, hydrogenated vegetable oils predominantly in the β and β′ forms are employed, especially those predominantly in the β form. The term “predominantly” means that at least 25%, in particular at least 50%, preferably at least 75%, of the crystals are in the preferred polymorphous form.

It is particularly preferred to employ hydrogenated soybean oil with a proportion of more than 50%, in particular more than 75%, in particular more than 90%, of β and/or β′ form.

In a preferred embodiment, the coated preparations of the invention are provided with a coating material which comprises at least one compound selected from the group consisting of benzoic acid and/or salts of benzoic acid and/or esters of benzoic acid and/or derivatives of benzoic acid and/or salts of benzoic acid derivatives and/or esters of benzoic acid derivatives.

Salts of benzoic acid or benzoic acid derivatives which may be mentioned are alkali metal and/or alkaline earth metal salts of benzoic acid, and ammonium benzoate. Alkali metal salts which may be mentioned are: lithium, sodium, potassium and cesium benzoates. Sodium and/or potassium benzoates are particularly preferred. Alkaline earth metal salts which may be mentioned are calcium, strontium and magnesium benzoates, with calcium and magnesium benzoates being particularly preferred.

Esters of benzoic acid or benzoic acid derivatives which may be mentioned are the esters of benzoic acid or benzoic acid derivatives with alcohols. Suitable alcohols are both monofunctional and bifunctional as well as polyfunctional (more than 2 hydroxyl groups). Suitable alcohols are both linear and branched alcohols. Alcohols having 1 to 10 C atoms are particularly suitable, especially having 1 to 6 C atoms. Examples which may be mentioned are: methanol, ethanol, n-propanol, isopropanol, n-butyl alcohol, i-butyl alcohol. Methanol, ethanol, n-propanol and isopropanol are preferred. Suitable esters of benzoic acid and benzoic acid derivatives are in addition esters with alcohols having more than one hydroxyl group such as, for example, glycols, an example which may be mentioned being 1,2-propanediol, or trioles such as, for example, glycerol.

Preference is given to methyl benzoate, ethyl benzoate, n-propyl benzoate and isopropyl benzoate, and ethyl p-hydroxybenzoate, sodium methyl p-hydroxybenzoate, propyl p-hydroxybenzoate, sodium propyl p-hydroxybenzoate, methyl p-hydroxybenzoate and sodium methyl p-hydroxybenzoate.

Derivatives of benzoic acid are compounds which have one, two, three, four or five substituents on the aromatic ring.

Examples of substituents for the carboxylic acids of the invention include C₁-C₈-alkyl, C₂-C₈-alkenyl, aryl, aralkyl and aralkenyl, hydroxymethyl, C₂-C₈-hydroxyalkyl, C₂-C₈-hydroxyalkenyl, aminomethyl, C₂-C₈-aminoalkyl, cyano, formyl, oxo, thioxo, hydroxyl, mercapto, amino, carboxyl or imino groups. Preferred substituents are C₁-C₈-alkyl, hydroxymethyl, hydroxyl, amino and carboxyl groups.

Preferred benzoic acid derivatives are mono-, di and tri-hydroxy-substituted benzoic acids.

Examples which may be mentioned are m-hydroxybenzoic acid, o—hydroxybenzoic acid and p-hydroxybenzoic acid.

Examples which may be mentioned are 2,4-dihydroxybenzoic acid, 2,5-dihydroxybenzoic acid, 2,5-dihydroxybenzoic acid, 2,6-dihydroxybenzoic acid, 3,5-dihydroxybenzoic acid, 3,6-dihydroxybenzoic acid and 2,4,6-trihydroxybenzoic acid.

Mono-hydroxy-substituted benzoic acids are particularly preferred, especially p-hydroxybenzoic acid.

In a further embodiment, said benzoates can be employed mixed with one another.

Preferred coating materials include hydrogenated vegetable oils including triglycerides such as, for example, hydrogenated cottonseed, corn, peanut, soybean, palm, palm kernel, babassu, sunflower and safflower oils. Preferred hydrogenated vegetable oils include hydrogenated palm oil, cottonseed oil and soybean oil. The most preferred hydrogenated vegetable oil is hydrogenated soybean oil. Other fats and waxes derived from plants and animals are likewise suitable.

The following table contains particularly suitable coating materials

| | | Melting | |
|---|---|---|---|
| Name | Composition | range | CAS No./INCI |
| Cutina CP from | synthetic cetyl | 46-51° C. | 95912-87-1 |
| Cognis | palmitate | | Cetyl Palmitate |
| Edenor NHTI-G from | triglyceride | 56-60° C. | 67701-27-3* |
| Cognis | | | |
| Edenor NHTI-V from | triglyceride | 57-60° C. | 67701-27-3* |
| Cognis | | | EINECS 266-945-8 |

| | | Melting | |
|---|---|---|---|
| Name | Composition | range | CAS No./INCI |
| Japanwachsersatz | complex mixture of wax esters, | 49-55° C. | Rhus succedanea |
| Kahl - Wachsraffinerie | mainly palmitic acid glycerol | | |
| | esters | | |
| Vegeol PR-267 from | 25% Colzawar 46, 75% Rucawar FH | 70° C. | |
| AARHUS OLIE | | | |
| Vegeol PR-272 from | 80% Shoguwar FH, 20% Shoguwar 41 | 67° C. | |
| AARHUS OLIE | | | |
| Vegeol PR-273 from | 85% Shoguwar FH, 15% Shoguwar 41 | 67° C. | |
| AARHUS OLIE | | | |
| Vegeol PR-274 from | 90% Shoguwar FH, 10% Shoguwar 41 | 67° C. | |
| AARHUS OLIE | | | |
| Vegeol PR-275 from | 95% Shoguwar FH, 5% Shoguwar 41 | 67° C. | |
| AARHUS OLIE | | | |
| Vegeol PR-276 from | 80% Soyalu FH, 20% Soyalu 41 | 65° C. | |
| AARHUS OLIE | re-esterified | | |
| Vegeol PR-277 from | 85% Soyalu FH, 15% Soyalu 41 | 65° C. | |
| AARHUS OLIE | re-esterified | | |
| Vegeol PR-278 from | 90% Soyalu FH, 10% Soyalu 41 | 66° C. | |
| AARHUS OLIE | re-esterified | | |
| Vegeol PR-279 from | 95% Soyalu FH, 5% Soyalu 41 | 67° C. | |
| AARHUS OLIE | re-esterified | | |
| Tefacid from | palm Kernel oil Tefacid Palmic 90 | 65° C. | 57-10-3 |
| Karlshamns | | | |
| Soybean fat powder | | 65-70° C. | |
| from Sankyu/Japan | | | |
| Kollicoat EMM 30 D | 2-propenoic acid, 2-methyl-, methyl ester | | 9010-88-2 |
| from BASF | polymer with ethyl 2-propenoate | | |
| Kollicoat MAE | ethyl acrylate/methacrylic acid | | 25212-88-8 |
| from BASF | copolymer | | Acrylates |
| | | | Copolymer |
| Acronal S 600 | styrene/acrylic ester | | |
| from BASF | copolymer | | |
| Diofan 233 D | vinylidene chloride/methyl acrylate | | |
| from BASF | copolymer | | |
| Poligen WE 3 | ethylene/acrylic acid | | |
| from BASF | copolymer | | |
| Dispersion 1286 | polyethylene dispersion in water | | |
| from Paramelt | | | |
| Aquasil PE 1286 | | | |

The coating materials can be employed both singly and mixed with one another. In one embodiment of the invention, talc and/or aluminum silicates such as, for example, zeolites, feldspars or feldspathoids are added to the coating material(s). Talc=Mg₃(OH)₂/Si₄O₁₀, also called soapstone.

It is possible to employ for the coating for example a liquid which is as highly concentrated as possible and is still sprayable, such as, for example, a 50% by weight aqueous or nonaqueous solution or dispersion of one or more of said coating materials. It is likewise possible to employ coating materials in powder form.

In a further embodiment, the preparations of the invention may comprise further constituents besides the diformates. The choice of the further constituents depends on the chosen area of use of the preparations obtainable in this way. The following substances are mentioned as examples of further constituents for the purposes of the present invention: organic acids, vitamins, carotenoids, trace elements, antioxidants, enzymes, amino acids, minerals, emulsifiers, stabilizers, preservatives, binders, anticaking agents and/or flavorings.

In a preferred embodiment, the preparations of the invention may additionally comprise at least one short-chain carboxylic acid and/or at least one salt of the short-chain carboxylic acid and/or at least one ester of the short-chain carboxylic acid and/or at least one derivative of the short-chain carboxylic acid.

Short-chain carboxylic acids mean for the purposes of the invention carboxylic acids which may be saturated or unsaturated and/or straight-chain or branched or cyclic and/or aromatic and/or heterocyclic. “Short-chain” means for the purposes of the invention carboxylic acids containing up to 12 C atoms, in particular up to 10 C atoms, in particular up to 8 C atoms.

The short-chain carboxylic acids normally have a molecular weight of less than 750. The short-chain carboxylic acids for the purposes of the invention may have one, two, three or more carboxyl groups. The carboxyl groups may be wholly or partly an ester, anhydride, lactone, amide, imidic acid, lactam, lactim, dicarboximide, carbohydrazide, hydrazone, hydroxamic acid, hydroximic acid, amidine, amide oxime or nitrile.

Derivatives of the short-chain carboxylic acids are short-chain carboxylic acids which are mono-, di-, tri- or polysubstituted along the carbon chain or the cyclic structure. Examples of substituents of the carboxylic acids of the invention include C₁-C₈-alkyl, C₂-C₈-alkenyl, aryl, aralkyl and aralkenyl, hydroxymethyl, C₂-C₈-hydroxyalkyl, C₂-C₈-hydroxyalkenyl, aminomethyl, C₂-C₈-aminoalkyl, cyano, formyl, oxo, thioxo, hydroxyl, mercapto, amino, carboxyl or imino groups. Preferred substituents are C₁-C₈-alkyl, hydroxymethyl, hydroxyl, amino and carboxyl groups.

Examples which may be mentioned of short-chain carboxylic acids of the invention are formic acid, acetic acid, propionic acid, butyric acid, lactic acid, citric acid, isobutyric acid, valeric acid, isovaleric acid, pivalic acid, oxalic acid, malonic acid, salicylic acid, tartaric acid, succinic acid, glutaric acid, glyceric acid, glyoxylic acid, adipic acid, pimelic acid, suberic acid, azelaic acid, sebacic acid, propiolic acid, crotonic acid, isocrotonic acid, elaidic acid, maleic acid, fumaric acid, muconic acid, citraconic acid, mesaconic acid, camphoric acid, o.m.p.-phthalic acid, naphthoic acid, toluic acid, hydratropic acid, atropic acid, cinnamic acid, isonicotinic acid, nicotinic acid, bicarbamic acid, 4,4′-dicyano-6,6′-binicotinic acid, 8-carbamoyloctanoic acid, 1,2,4-pentanetricarboxylic acid, 2-pyrrolecarboxylic acid, 1,2,4,6,7-naphthalenepentaacetic acid, malonaldehydic acid, 4-hydroxyphthalamic acid, 1-pyrazolecarboxylic acid, gallic acid or propanetricarboxylic acid.

Salts of the short-chain carboxylic acids which may be mentioned are alkali metal and/or alkaline earth metal salts and ammonium salts. Alkali metal salts which may be mentioned are: lithium, sodium, potassium and cesium salts. Sodium and/or potassium salts are particularly preferred. Alkaline earth metal salts which may be mentioned are calcium, strontium and magnesium salts, particularly preferably calcium and magnesium salts.

Esters of the short-chain carboxylic acids which may be mentioned are the esters with alcohols. Suitable alcohols are both monofunctional and bifunctional, as well as polyfunctional (more than 2 hydroxyl groups) ones. Suitable alcohols are both linear and branched alcohols. Particularly suitable alcohols have from 1 to 10 C atoms, in particular from 1 to 6 C atoms. Examples which may be mentioned are: methanol, ethanol, n-propanol, isopropanol, n-butyl alcohol, i-butyl alcohol. Preference is given to methanol, ethanol, n-propanol and isopropanol. Further suitable esters are esters with alcohols having more than one hydroxyl group, such as, for example, glycols, and an example which may be mentioned is 1,2-propanediol, or triols such as, for example, glycerol.

Preferred esters are methyl, ethyl, n-propyl and isopropyl esters.

It is particularly preferred to use the acids and/or salts and/or esters of formic acid, acetic acid, propionic acid, fumaric acid, salicylic acid, citric acid, lactic acid and/or tartaric acid.

The use of sodium propionate is very particularly preferred.

The use of short-chain carboxylic acids which are described as coating materials w) is very particularly preferred.

In a further embodiment, said short-chain carboxylic acids, salts and/or esters can be employed mixed with one another.

Suitable compounds are the compounds mentioned under coating materials x).

In a further embodiment, the preparations of the invention may comprise carriers as well as diformates. In this embodiment, the diformates are preferably bound to the carriers. Suitable carriers are “inert” carrier materials, i.e. materials which show no adverse interactions with the components employed in the preparation of the invention. It is, of course, necessary that the carrier material is acceptable for the particular uses as auxiliary, e.g. in animal feeds. Suitable carrier materials are both inorganic and organic carriers. Examples to be mentioned of suitable carrier materials are: low molecular weight inorganic or organic compounds and high molecular weight organic compounds of natural or synthetic origin. Examples of suitable low molecular weight inorganic carriers are salts such as sodium chloride, calcium carbonate, sodium sulfate and magnesium sulfate, kieselguhr or silica or silica derivatives such as, for example, silicon dioxides, silicates or silica gels. Examples of suitable organic carriers are, in particular, sugars such as, for example, glucose, fructose, sucrose, and dextrins and starch products. Examples to be mentioned of high molecular weight organic carriers are: starch and cellulose products such as, in particular, corn starch, corn cob meal, ground rice husks, wheat bran or cereals meals such as, for example, wheat meal, rye meal, barley meal and oatmeal or bran or mixtures thereof.

In a further embodiment, the preparations of the invention may comprise additives. “Additives” mean substances which improve the product properties such as dusting characteristics, flow properties, water-uptake capacity and storage stability. Additives and/or mixtures thereof may be based on sugars, e.g. lactose or maltodextrin, based on cereal or leguminous products, e.g. corn cob meal, wheat bran and soybean meal, based on mineral salts, inter alia calcium, magnesium, sodium, potassium salts, as well as D-pantothenic acid or the salts thereof themselves (D-pantothenic acid salt prepared chemically or by fermentation).

The preparations of the invention may comprise the further ingredients, carriers and additives in mixtures.

The preparations of the invention are normally in solid form such as, for example, powder, agglomerate, adsorbate, granules and/or extrudate. The powders normally have a average particle size of from 1 μm to 10 000 μm, in particular 20 μm to 5000 μm.

The average particle size distribution is determined as follows:

The products in powder form are investigated in a Mastersizer S instrument from Malvern Instruments GmbH, Serial Number: 32734-08. To describe the width of the particle size distrbution, the values of D(v,0.1), D(v,0.5) and D(v,0.9) are determined for the powders, and the average particle size of the overfeeding D[4,3] is indicated.

Production Processes

Processes suitable for producing the preparations of the invention are all those which result in preparations whose surface is at least 50%, in particular at least 70% and very particularly preferably at least 80, especially at least 90, % covered.

One aspect of the present invention relates to a process for producing the preparations of the invention, in which the diformates are coated by desublimation of the coating material.

In this process, the coating material is sublimed and desublimed, i.e. deposited, on the preparations to be coated. Processes of this type are known from the literature as sublimation or desublimation processes. The process of the invention makes it possible to apply the coating material homogeneously and in desired layer thicknesses. The process of sublimation and desublimation is described in Ullmann's Encyclopedia of industrial Chemistry, Sixth Edition, 2000 Electronic Release, chapter 4.1. Suitable evaporators (sublimators) are those described in Ullmann's, loc. cit., chapter 5.1, condensers (desublimators) described in chapter 5.2, and apparatus designs and connections are described in FIGS. 5, 6, 7, 9 and 10, to which express reference is made here. A fluidized bed may be mentioned as a further possible condenser.

In a preferred embodiment, the coating material employed in this process is at least one compound from substance class x).

One aspect of the present invention relates to a process for producing coated preparations comprising diformates, in which diformates are introduced, where appropriate together with further ingredients and/or additives, into a suitable apparatus and coated with a coating material, where appropriate with addition of further ingredients.

Examples of suitable apparatuses which may be mentioned are: mixers, fluidized bed, coating drums, Kugelcoaters, etc.

The diformates which are advantageously in powder form (e.g. in crystalline, amorphous form, in the form of adsorbates, extrudates, granulates and/or agglomerates) are for this purpose introduced into the suitable apparatus, preferably into a fluidized bed or a mixer. The diformates are introduced where appropriate together with so-called additives and further ingredients. Plowshares, paddles, screws or the like ensure more or less vigorous mixing of the product. Conventional examples are plowshare mixers, orbiting screw mixers or similar apparatuses.

It is also possible to employ very shallow, box- or trough-shaped designs having one or more screws. Further designs are high-speed mixers such as, for example, the Turbolizer® mixer/coater from Hosokawa Micron B.V., and all types of drum coaters or coating drums.

An alternative possibility is mixing of the product by movement of the entire container. Examples thereof are tumbling mixers, drum mixers or the like. A further possibility is to use pneumatic mixers. Mixing of solids is described for example in Ullmann's Encyclopedia of Industrial Chemistry, Sixth Edition, 2000, Mixing of Solids.

The coating can be carried out either directly in the apparatus downstream.

Said process can be carried out either continuously or batchwise (in mixers operating batchwise or continuously as appropriate).

It may be necessary in some cases when applying the coating material or immediately after/before this to add dusting agents such as talc, silicates or the like to prevent sticking.

The metering/addition of the coating material takes place where appropriate together with further ingredients normally through devices for dropwise or spray application. Examples thereof are injectors, spray heads, single-fluid or multifluid nozzles, in rare cases rotating dripping or atomizing devices. In the simplest case, local addition as concentrated jet stream is also possible.

One aspect of the present invention relates to a process for producing coated preparations comprising diformates, in which coating material is introduced, where appropriate with the addition of further ingredients, into a suitable apparatus, and diformates are added, where appropriate together with further ingredients and/or additives.

In one embodiment of this process, the initially solid coating material is put into a suitable apparatus and melted or softened as a result of heating of the wall of the apparatus or of the shaft or as a result of the mechanical energy input. The diformates and where appropriate further ingredients and/or additives are added and coated with the molten or softened coating material.

In one embodiment of this process, carriers are introduced into the mixer in addition to the coating material and premixed where appropriate and, as a result of high mechanical energy input in the same or in separate apparatuses (examples are all the mixers already mentioned as well as low-speed mills and dryers), the diformates and, where appropriate, further ingredients and/or additives are coated.

The addition of coating materials can take place under superatmospheric, atmospheric or subatmospheric pressure, preferably under atmospheric and subatmospheric pressure.

It may be advantageous in some cases to preheat or cool the diformates and, where appropriate, further ingredients and/or additives and/or the coating material (change in viscosity, change in the wetting properties, influence on solidification properties), and feed in or withdraw heat via the container wall and/or the mixing implements. It may be necessary in some cases to remove water vapors or solvent vapors. The wetting properties can also be changed by adding surface-active substances such as emulsifiers or the like.

To improve the coating properties, it may be advantageous for the mixer to be evacuated and, where appropriate, blanketed with protective gas. This should be repeated several times depending on the coating material.

The addition of the diformates, where appropriate further ingredients and/or additives, and of coating materials may if required take place at different sites in the apparatus.

The site of addition of coating materials or additives is varied according to the requirements and selected by the skilled worker. The devices described above for dropwise or spray application are, depending on requirements, disposed above the product layer (top spray process) or are immersed in the product layer (from the side through walls of the apparatus or from below through the bases of apparatuses or fluidized beds).

In a further embodiment of the present invention, the preparations of the invention are produced batchwise or continuously in fluidized beds. The particles are agitated by the fluidizing gas which is hot or cooled where appropriate. Suitable as fluidizing gas is, for example, air or else inert gas (e.g. nitrogen). It may be worthwhile in some cases to feed in or withdraw heat via the container wall and via heat exchanger surfaces immersed in the fluidized bed. Suitable fluidized beds, and the necessary peripherals, are known in the art.

The batchwise or continuous metering and, where appropriate, the preheating of the diformates, where appropriate of the further ingredients and additives, takes place with the aid of the devices described above, which are known to the skilled worker.

For example, the diformates can be introduced into a fluidized bed. They are fluidized and coated by spraying on an aqueous or nonaqueous solution or dispersion or a melt of a suitable coating material.

Internals known in the prior art which assist defined mixing of the solid to be coated are beneficial. Examples thereof are rotary displacers, Wurster pipes or else specially fabricated fluidized bed base geometries (inclination and/or perforation of the base) or assisting defined agitation of the solid by sensibly disposed nozzles, e.g. tangentially disposed single- or twin-fluid or multifluid nozzles.

The coated preparations comprising diformates may in some cases be produced advantageously in a combination of mixer and fluidized bed.

One aspect of the present invention relates to a process for producing coated preparations comprising diformates, in which diformates are dispersed, where appropriate together with further ingredients and/or additives, in melts of suitable coating materials, and then the dispersions obtained in this way are divided and solidified.

In one embodiment of this process it is possible for the diformates, where appropriate together with further ingredients and/or additives, to be employed in the form of a melt.

In a further embodiment, the preparations of the invention are obtained by the diformates (and where appropriate the further ingredients and/or additives) being suspended in melts of suitable coating materials and then the dispersions obtained in this way being atomized and/or divided and allowed to solidify. Suitable coating materials in the form of melts are substances whose melting point is lower than the melting point of the diformates to be suspended. Examples which may be mentioned are fats, waxes, oils, lipids, lipid-like and lipid-soluble substances with appropriate melting points.

These suspensions are then atomized in a stream of cooled gas—with and without use of dusting agents—so that coated preparations comprising diformates are produced. These processes are known to the skilled worker for example under the names spray cooling, spray solidification, prilling or melt encapsulation, and solidifying on cooling belts, rolls, pelletizing plates and belts.

The melts are preferably produced in a first step before the diformates are added and suspended. The suspending can take place batchwise in a stirred vessel or else continuously in, for example, pumps suitable for this purpose or simply in injectors and pipe lines as a result of sufficiently high turbulence. It is also possible to use static mixers. Protective heating of the necessary parts of the system—including the lines and atomizing units—is known to the skilled worker.

Air and nitrogen are suitable and preferred as cooling gas. The gas flow can be cocurrent, countercurrent or crossflow. The process can be carried out in conventional spraying, prilling towers or other containers. Fluidized beds with and without holdup are likewise suitable. The process can be operated batchwise or continuously. The solid can be removed for example in cyclones or filters. Alternatively, it is conceivable for the solid to be collected, with and without after-cooling, in fluidized beds or mixers.

Suitable atomizing units are nozzles (single- and twin-fluid nozzles or special designs) and atomizing wheels or atomizing disks or plates or atomizing baskets—or special designs thereof.

In a further embodiment, the dispersions obtainable in this way are atomized and solidified in liquids in which neither the diformates nor the coating materials are soluble. A conventional solid/liquid separation with subsequent drying leads to the preparation of the invention.

A further aspect of the present invention relates to a process for producing coated preparations comprising diformates, in which diformates, where appropriate further ingredients and/or additives, are dispersed in a coating material, in particular a lipophilic coating material, emulsified in an aqueous solution of a protective colloid, preferably gelatin or/and gelatin derivatives or/and gelatin substitutes with addition of one or more substances from the group of mono-, di- and polysaccharides, and subsequently subjected to spray drying.

Very fine-particle diformates are preferably employed in this process and are obtained for example by precipitation, crystallization, spray drying or grinding.

In one embodiment, one or more emulsifiers and/or stabilizers can be added to the diformates before the dispersion in the lipophilic component.

Suitable lipophilic coating materials are melts of fats, oils, waxes, lipids, lipid-like and lipid-soluble substances having a melting point which is lower than the melting point of the diformates employed.

The dispersions obtained in this way (oil droplets containing the diformates) are emulsified in a subsequent process step in an aqueous solution of a protective colloid, preferably gelatin or/and gelatin derivatives or/and gelatin substitutes with addition of one or more substances from the group of mono-, di- and polysaccharides, preferably corn starch. The emulsions obtained in this way are subjected to a shaping by spraying and subsequent or simultaneous drying.

In a further embodiment, the coated preparations of the invention comprise diformates bound to a carrier.

The preparations bound to a carrier are produced by production processes known to the skilled worker, such as, for example, by adsorbing the preparations of the invention in liquid form onto the carrier substances.

Applications

The preparations of the invention are suitable for use in feeds for animals (animal feeds). Examples which may be mentioned are: pigs, cows, poultry and domestic animals, especially piglets, breeding sows, fattening pigs and calves.

The preparations of the invention are particularly suitable as addition to animal feeds in the form of feed additives.

Feed additives are, according to the Animal Feeds Act, in particular substances intended to be added singly or in the form of preparations to animal feeds in order to
influence the characteristics of the animal feed or of the animal products,
cover the animals' requirements for certain nutrients or active substances, or improve animal production, in particular by acting on the gastrointestinal flora or the digestibility of the animal feeds or by reducing nuisances caused by the animals' excreta, or
achieve particular nutritional purposes or cover certain temporary nutritional needs of the animals.

Feed additives also include substances which are approved as additives by a statutory instrument under § 4, para. 1, No. 3b of the German Animal Feeds Act.

The preparations of the invention are particularly suitable as addition to premixes for animal feeds. Premixes are mixtures of minerals, vitamins, amino acids, trace elements and, where appropriate, enzymes. It is possible with the preparations of the invention to produce premixes comprising diformates.

A further aspect of the present invention relates to a process for producing a diformate-containing feed and/or feed additive, which comprises
(i) adding a coated preparation comprising diformates to a premix and
(ii) mixing the premix obtained in this way with the conventional ingredients of the feed and/or feed additive.

The preparations of the invention are particularly suitable as so-called “acidifiers”. Acidifiers means substances which reduce the pH. These include substances which reduce the pH in the substrate (e.g. animal feed) and those which reduce the pH in the animal's gastrointestinal tract.

The preparations of the invention are particularly suitable as performance enhancers. In a preferred embodiment, the preparations of the invention are employed as performance enhancers for pigs and poultry.

The compositions of animal feeds are such as to cover optimally the appropriate nutrient requirements of the particular species. Those generally chosen are vegetable feed components such as corn, wheat or barley meal, unextracted soybean meal, extracted soybean meal, extracted linseed meal, extracted rapeseed meal, grass meal or pea meal as crude protein sources. In order to ensure an appropriate energy content of the feed, soybean oil or other animal or vegetable fats are added. Since the vegetable protein sources comprise only an inadequate amount of some essential amino acids, feeds are frequently supplemented with amino acids. These are in particular lysine and methionine. In order to ensure the supply of minerals and vitamins to the agricultural livestock, minerals and vitamins are also added. The type and amount of the added minerals and vitamins depends on the species and is known to the skilled worker (see, for example, Jeroch et al., Ernährung landwirtschaftlicher Nutztiere, Ulmer, UTB). Complete feeds which contain all the nutrients in the ratio to one another which covers requirements can be used to cover the nutrient and energy requirements. It may form the sole feed for the animals. Alternatively, a feed supplement can be added to a cereal grain feed. This comprises protein-, mineral- and vitamin-rich feed mixes which supplement the feed in a sensible way.

The preparations of the invention are further suitable as preservatives, especially as preservatives for green fodder and/or animal feed.

It has been found that the preparations of the invention can be employed advantageously in the production of silage. They speed up lactic fermentation and prevent after-fermentation and inhibit the development of harmful yeasts. A further aspect of the invention therefore relates to the use of the preparations of the invention as ensiling agents (ensiling aids).

A further aspect of the present invention relates to the use of the preparations of the invention in fertilizers.

### EXAMPLES

All Percentage Data are Percent by Weight

Particle Size Distribution:

The resulting products in powder form were investigated in a Mastersizer S instrument from Malvern Instruments GmbH, Serial Number: 32734-08. To describe the width of the particle size distribution, the values of D(v,0.1), D(v,0.5) and D(v,0.9) were determined, and the average particle size of the distribution D[4,3] has been indicated.

The potassium diformate crystals employed in Examples 1 to 4 already contained 2.5% Tefacid and/or 0.8% Sipernat 22. The measured particle size distribution of these crystals to be coated can be indicated in the following way (the values in parentheses characterize the second batch which was employed):

| | | |
|---|---|---|
| D(v, 0.1) = | 208 μm | (223 μm) |
| D(v, 0.5) = | 402 μm | (440 μm) |
| D(v, 0.9) = | 666 μm | (726 μm) |
| D[4, 3] = | 419 μm | (458 μm) |

The particle size distribution of a compact and spray granules were determined by sieve analysis.

Tefacid® (Karlshamns)=palm kernel oil=Tefacid Palmic 90 (CAS No. 57-10-3) Sipernat® 22 (Degussa)=silica

### Example 1a

### Coating of Potassium Diformate Crystals in a Mixer

2500 g of potassium diformate crystals (D[4,3]=0.419 μm) were introduced into a heatable plowshare mixer (Loedige type M5 GR) and heated to 53° C. while stirring at about 60 rpm over the course of about 15 min.

In parallel with this, 441 g Tefacid® were heated to 76° C. and melted in a drying oven.

The liquid Tefacid® was then poured over the course of a few minutes into the plowshare mixer. Following this, the mixture was homogenized at the same speed of 60 rpm in the plowshare mixer for 10 minutes.

The plowshare mixer was then switched from heating to cooling by passing cool water through the jacket. While stirring, the coated potassium diformate crystals were cooled and discharged. Coated potassium diformate crystals with the following composition were obtained:
85% potassium diformate crystals, 15% Tefacid coating

### Examples 1b to 1f

Procedure analogous to Example 1a. All the examples were run in the plowshare mixer and led to coated products with the following composition:

85% potassium diformate crystals, 15% coating

| | | | Temperature of |
|---|---|---|---|
| | | Temperature in | coating material before |
| Example | Coating material | mixer | addition to the mixer |
| 1a | Tefacid | 53° C. | 76° C. |
| 1b | Cutina CP | 40° C. | 63° C. |
| 1c | Japanwachsersatz | 43° C. | 52° C. |
| 1d | Edenor NHTI-G | 46° C. | 63° C. |
| 1e | Vegeol PR 267 | 58° C. | 77° C. |
| 1f | Vegeol PR 265 | 57° C. | 76° C. |

### Example 2a

### Fluidized Bed Coating of Potassium Diformate Crystals

The product to be coated comprised potassium diformate crystals with an average particle size D[4,3] of about 400-500 μm.

Cutina CP® was used as coating material.

A Niro-Aeromatic, type MP-1, laboratory fluidized bed was available for carrying out the tests. The receiver vessel employed was a plastic cone with a base inflow plate diameter of 110 mm and a perforated based with 12% free area.

The potassium diformate crystals (750 g) introduced into the fluidized bed was heated to a product temperature of about 40° C. while air-fluidizing at a rate of 30 m³/h. The coating material (132 g) was melted in a glass beaker in an oil bath at 70° C. and sprayed onto the potassium diformate crystals using a 1.2 mm twin fluid nozzle by reduced-pressure intake through a heated line at a spraying pressure of 2 bar with heated spraying gas. During the spraying process, the air rate was increased to about 80 m³/h in order to ensure thorough mixing and a uniform coating layer. The spraying time was 10 min, with the product temperature being about 40° C.

At an inlet air temperature of 35° C., the coated material was cooled in the fluidized bed to a temperature below 40° C. and discharged. Coated potassium diformate crystals with the following composition were obtained:
85% potassium diformate crystals, 15% Cutina CP coating.

### Examples 2b to 2e

Procedure analogous to Example 2a. All examples were run in the MP 1 laboratory fluidized bed and led to coated products with the following composition:

85% potassium diformate crystals, 15% coating

| | | | Temperature of |
|---|---|---|---|
| | | Product | coating material |
| | | temperature in the | before addition to |
| Example | Coating material | fluidized bed | the fluidized bed |
| 2a | Cutina CP | 40° C. | 70° C. |
| 2b | Japanwachsersatz | 30° C. | 75° C. |
| 2c | Japanwachsersatz | 40° C. | 75° C. |
| 2d | Edenor NHTI-G | 48° C. | 80° C. |
| 2e | Tefacid | 45° C. | 80° C. |

### Example 3a

### Fluidized Bed Coating of Potassium Diformate Crystals with Polymers

The product to be coated comprised potassium diformate crystals with an average particle size D[4,3] of about 400 to 500 μm.

Kollicoat EMN 30 D was used as coating material.

A Niro-Aeromatic, type MP-1, laboratory fluidized bed was available for carrying out the tests. The receiver vessel employed was a plastic cone with a base inflow plate diameter of 110 mm and a perforated based with 12% free area.

The potassium diformate crystals (750 g) introduced into the fluidized bed was heated to a product temperature of about 25-30° C. while air-fluidizing at a rate of 30 m³/h. The coating material (440 g Kollicoat EMN 30 D, equivalent to 132 g of solid) was sprayed onto the potassium diformate crystals using a 1.2 mm twin fluid nozzle at a spraying pressure of 1.5 bar. During the spraying process, the air rate was increased to about 50 m³/h in order to ensure thorough mixing and a uniform coating layer. The spraying time was 50 min. Coated Formi crystals were obtained with the composition:
85% potassium diformate crystals, 15% Kollicoat EMN 30 D coating.

### Examples 3b to 3f

Procedure analogous to Example 3a. All the examples were run in the MP 1 laboratory fluidized bed and led to coated products of the following composition:

85% potassium diformate crystals, 15% coating

| | | Product temperature |
|---|---|---|
| Example | Coating material | in the fluidized bed |
| 3a | Kollicoat EMN 30 D | <30° C. |
| 3b | Kollicoat MAE 30 DP + 15% | <43° C. |
| | triethyl citrate | |
| 3c | Diofan 233 D | <41° C. |
| 3d | Acronal S 600 | <41° C. |
| 3e | Aquasil PE 1286 | <41° C. |
| 3f | Poligen WE 3 | <51° C. |

### Examples 4a to 4t

### Fluidized Bed Coating of Potassium Diformate Crystals—Variation of the Coating Thickness

The product to be coated comprised potassium diformate crystals with an average particle size D[4,3] of about 400 to 500 μm.

A Niro-Aeromatic, type MP-1, laboratory fluidized bed was available for carrying out the tests. The receiver vessel employed was a plastic cone with a base inflow plate diameter of 110 mm and a perforated based with 12% free area.

Procedure analogous to Example 2a.

The temperature of the coating material before addition to the fluidized bed was 80° C. in each of Examples 4a to 4t.

| | | | | | Decomposition | | |
|---|---|---|---|---|---|---|---|
| | Formula | | | Product | with CaCO₃ in | | |
| | | Potassium | Coating | temperature in the | ml of gas evolved | | |
| Example | Coating [%] | diformate [%] | material | fluidized bed [° C.] | 200 min. | 600 min. | 1000 min. |
| 4a | 5.0 | 95.0 | Tefacid | 52-57 | 15 | 52 | 80 |
| 4b | 10.0 | 90.0 | Tefacid | 53-56 | 2 | 33 | 72 |
| 4c | 15.0 | 85.0 | Tefacid | 54-56 | 3 | 20 | 28 |
| 4d | 5.0 | 95.0 | Vegeol PR-267 | 46-48 | 2 | 25 | 60 |
| 4e | 10.0 | 90.0 | Vegeol PR-267 | 44-46 | 0 | 0 | 0 |
| 4f | 15.0 | 85.0 | Vegeol PR-267 | 44-46 | 0 | 0 | 0 |
| 4g | 5.0 | 95.0 | Vegeol PR-272 | 48 | 0 | 0 | 0 |
| 4h | 10.0 | 90.0 | Vegeol PR-272 | 47-51 | 0 | 0 | 0 |
| 4i | 15.0 | 85.0 | Vegeol PR-272 | 46-51 | 0 | 0 | 0 |
| 4j | 15.0 | 85.0 | Vegeol PR-273 | 50-53 | 0 | 0 | 0 |
| 4k | 15.0 | 85.0 | Vegeol PR-274 | 50-54 | 0 | 0 | 0 |
| 4l | 15.0 | 85.0 | Vegeol PR-275 | 53-56 | 0 | 0 | 0 |
| 4m | 15.0 | 85.0 | Vegeol PR-276 | 46-50 | 0 | 0 | 0 |
| 4n | 5.0 | 95.0 | Vegeol PR-277 | 47-51 | 0 | 0 | 0 |
| 4o | 15.0 | 85.0 | Vegeol PR-277 | 45-52 | 0 | 0 | 0 |
| 4q | 5.0 | 95.0 | Vegeol PR-278 | 51-53 | 0 | 8 | 26 |
| 4r | 15.0 | 85.0 | Vegeol PR-278 | 48-51 | 0 | 0 | 0 |
| 4s | 5.0 | 95.0 | Vegeol PR-279 | 51-52 | 0 | 0 | 0 |
| 4t | 15.0 | 85.0 | Vegeol PR-279 | 49-53 | 0 | 0 | 0 |

The CO₂ evolution was measured as indicated in the description.

As control value, the CO₂ evolution from potassium diformate was measured: it was >100 ml after a measurement time of 200 minutes.

The starting material for the coating tests of Examples 5 and 6 are spray-granulated potassium diformate dry powders with a particle size of from 400 μm to 2000 μm, which are referred to hereinafter as potassium diformate spray granules.

### Example 5

### Coating of Spray-Granulated Potassium Diformate Particles in a Mixer

2000 g of potassium diformate spray granules were introduced into a heatable plowshare mixer (Loedige type M5 GR) and heated to 53° C. while stirring at about 60 rpm over the course of about 15 min.

In parallel with this, 353 g Tefacid® were heated to 76° C. and melted in a drying oven.

The liquid Tefacid was then poured over the course of a few minutes into the plowshare mixer. Following this, the mixture was homogenized at the same speed of 60 rpm in the plowshare mixer for 10 minutes.

The plowshare mixer was then switched from heating to cooling by passing cool water through the jacket. While stirring, the coated potassium diformate granules were cooled and discharged. Coated potassium diformate spray granules with the following composition were obtained:
85% potassium diformate spray granules, 15% Tefacid coating

### Example 6

### Coating of Potassium Diformate Spray Granules in a Mixer—Addition of Talc to the Coating Material

2000 g of potassium diformate spray granules were introduced into a heatable plowshare mixer (Loedige type M5 GR) and heated to 53° C. while stirring at about 60 rpm over the course of about 15 min.

In parallel with this, 353 g Tefacid® were heated to 76° C. and melted in a drying oven. The liquid Tefacid® Was divided into three portions of equal size (each of 118 g), and two portions of talc (each of 118 g) were prepared.

118 g of liquid Tefacid® were poured over the course of about half a minute into the plowshare mixer. Homogenized for 3 minutes and then the first portion of talc (118 g) added. Stirring in for 3 minutes in turn. Add Tefacid® again, same manipulation as for the first addition. Again add talc and finally the last third of Tefacid® is added.

The coated potassium diformate granules to which talc had been added was homogenized at 60 rpm with heated jacket for 5 min.

The plowshare mixer was then switched from heating to cooling by passing cold water through the jacket. While stirring (15 min), the coated potassium diformate granules were cooled and discharged. Coated potassium diformate spray granules with the following composition were obtained:
77.2% potassium diformate spray granules, 13.6% Tefacid coating, 9.2% talc

The starting material for the coating tests of Example 7 is compacted potassium diformate dry powder with a particle size of from 1000 μm to 2000 μm, which are referred to hereinafter as potassium diformate compact. The compact was produced from potassium diformate crystals.

### Example 7

### Coating of Potassium Diformate Compacts in a Mixer

2000 g of potassium diformate compact were introduced into a heatable plowshare mixer (Loedige type M5 GR) and heated to 53° C. while stirring at about 60 rpm over the course of about 15 min.

In parallel with this, 353 g Tefacid® were heated to 76° C. and melted in a drying oven.

The liquid Tefacid® was then poured over the course of a few minutes into the plowshare mixer. Following this, the mixture was homogenized at the same speed of 60 rpm in the plowshare mixer for 10 minutes.

The plowshare mixer was then switched from heating to cooling by passing cool water through the jacket. While stirring, the coated potassium diformate compact were cooled and discharged. Coated potassium diformate compact with the following composition was obtained:
85% potassium diformate compact, 15% Tefacid coating

1. A coated preparation comprising
at least one diformate of the general formula
XH(COOH)₂, where X is Na, K, Cs, NH₄.

2. A preparation as claimed in claim 1, wherein potassium diformate is employed as diformate.

3. A preparation as claimed in either of the preceding claims, wherein the preparation comprises further ingredients and/or additives and/or carriers.

4. A preparation as claimed in any of the preceding claims, wherein the coating material employed is at least one compound selected from the group consisting of
a) polyalkylene glycols, especially polyethylene glycols with a number average molecular weight of about 400 to 15 000, such as, for example, 400 to 10 000;
b) polyalkylene oxide polymers or copolymers with a number molecular weight of about 4000 to 20 000, in particular block copolymers of polyoxyethylene and polyoxypropylene.
c) Substituted polystyrenes, maleic acid derivatives and styrene/maleic acid copolymers
d) polyvinylpyrrolidones with a number average molecular weight of about 7000 to 1 000 000;
e) vinylpyrrolidone/vinyl acetate copolymers with a number average molecular weight of about 30 000 to 100 000
f) polyvinyl alcohol with a number average molecular weight of about 10 000 to 200 000, polyphthalic acid vinyl esters
g) hydroxypropylmethylcellulose with a number average molecular weight of about 6000 to 80 000.
h) Alkyl (meth)acrylate polymers and copolymers with a number average molecular weight of about 100 000 to 1 000 000, especially ethyl acrylate/methyl methacrylate copolymers and methacrylate/ethyl acrylate copolymers,
i) polyvinyl acetate with a number average molecular weight of about 250 000 to 700 000, where appropriate stabilized with polyvinylpyrrolidone
j) polyalkylenes, especially polyethylenes
k) phenoxyacetic acid/formaldehyde resin
l) cellulose derivatives such as ethylcellulose, ethylmethylcellulose, methylcellulose, hydroxypropylcellulose, hydroxypropylmethylcellulose, carboxymethylcellulose, celluloseacetate phthalate
m) animal, vegetable or synthetic fats
n) animal, vegetable or synthetic waxes or chemically modified animal, vegetable waxes such as beeswax, candelilla wax, carriauba wax, montan ester wax and rice germ oil wax, spermaceti, lanolin, jojoba wax, Sasol wax, Japan wax or Japan wax substitute.
o) Animal and vegetable proteins such as, for example, gelatin, gelatin derivatives, gelatin substitutes, casein, whey, keratin, soybean protein; zein and wheat protein
p) mono- and disaccharides, oligosaccharides, polysaccharides, e.g. starches, modified starches and pectins, alginates, chitosan, carrageenans
q) vegetable oils, e.g. sunflower, safflower, cottonseed, soybean, corn germ, olive, rape (seed), linseed, olive, coconut, (oil) palm kernel oil and palm oil.
r) synthetic or semisynthetic oils, e.g. medium chain-length triglycerides or mineral oils
s) animal oils such as, for example, herring, sardine and whale oil
t) hardened (hydrogenated or partially hydrogenated) oils/fats such as, for example, from the abovementioned in particular hydrogenated palm oil, hydrogenated cottonseed oil, hydrogenated soybean oil
u) lacquer coatings such as, for example, terpenes, especially shellac, tolu balsam, Peru balsam, sandarac and silicone resins
v) fatty acids, both saturated and mono- and polyunsaturated C6 to C24 carboxylic acids
w) silicas
x) benzoic acid and/or salts of benzoic acid and/or esters of benzoic acid and/or derivatives of benzoic acid and/or salts of benzoic acid derivatives and/or esters of benzoic acid derivatives.

5. A preparation as claimed in any of the preceding claims, which is in the form of a powder having an average particle size of from 1 μm to 10000 μm, in particular 20 μm to 5000 μm.

6. A process for producing coated preparations as claimed in at least one of the preceding claims, in which
(i) at least one diformate is mixed where appropriate with further ingredients and/or additives
(ii) the mixture obtained in this way is coated with a coating material, where appropriate together with other ingredients.

7. A process for producing coated preparations as claimed in at least one of the preceding claims, in which
(i) coating material is introduced into a suitable apparatus, where appropriate with the addition of further ingredients
(ii) at least one diformate is added, where appropriate together with further ingredients and/or additives.

8. A process for producing preparations as claimed in at least one of the preceding claims, in which the diformates are applied to a carrier material before the coating.

9. A process for producing coated preparations as claimed in at least one of the preceding claims, in which
(i) at least one diformate is dispersed, where appropriate together with further ingredients and/or additives, in melts of suitable coating materials
(ii) the dispersions obtained in this way are divided and solidified.

10. A process for producing coated preparations as claimed in at least one of the preceding claims, in which
(i) at least one diformate is dispersed where appropriate together with further ingredients and/or additives in a coating material, in particular a lipophilic coating material,
(ii) emulsified in an aqueous solution of a protective colloid, preferably gelatin or/and gelatin derivatives or/and gelatin substitutes with the addition of one or more substances from the group of mono-, di- of polysaccarides,
(iii) and subjected to a shaping by spraying by subsequent or simultaneous drying.

11. A process for producing coated preparations as claimed in at least one of the preceding claims in which at least one diformate is coated by desublimation of the coating material.

12. The use of a preparation as claimed in at least one of the preceding claims in premixes for animal feeds.

13. The use of a preparation as claimed in at least one of the preceding claims in feed additives and/or animal feeds, in particular for pigs, poultry and calves.

14. A process for producing a feed and/or feed additive comprising at least one diformate, which comprises
(i) adding a preparation as claimed in any of claims 1 to 5 to a premix
(ii) mixing the premix obtained in this way with the other ingredients of the feed and/or feed additive.

15. An animal feed comprising a preparation as claimed in at least one of the preceding claims.

16. The use of a preparation as claimed in at least one of the preceding claims as performance enhancer and/or growth promoter.

17. The use of a preparation as claimed in at least one of the preceding claims as an acidifier.

18. The use of a preparation as claimed in at least one of the preceding claims as a preservative.

19. The use of a preparation as claimed in at least one of the preceding claims as ensiling agent.

20. The use of a preparation as claimed in at least one of the preceding claims in fertilizers.
